(19) United States
(12) Patent Application Publication
(10) Pub. No.: US 2026/0064710 A1
(43) Pub. Date: Mar. 5, 2026

(54) PHASED TRANSFORMATION DEPLOYMENT SYSTEM

(71) Applicant: Coalesce Automation, Inc., Portland, OR (US)

(72) Inventors: Kyle Nova, Seattle, WA (US); Michael Xu, Boulder, CO (US); Scott Brabson, Bailey, CO (US)

(21) Appl. No.: 18/821,627

(22) Filed: Aug. 30, 2024

(51) Int. Cl. G06F 16/25

(52) U.S. Cl. CPC G06F 16/254

(57) ABSTRACT

A phased transformation deployment system that maintains the current state of a set of objects stored in a data warehouse and receives a desired state to be achieved by modifying the objects. The system generates a set of transformations by comparing the current and desired states, where each transformation modifies an object from the object's current to the object's desired state. The transformations are categorized into predefined groups based on similarity, such as removal, alteration, and addition. For each group, the system generates deployment phases that prioritize transformations based on dependencies between the transformations. The system implements the deployment phases in a predetermined order.

### BACKGROUND

An object (e.g., materialization) represents a discrete unit of data or functionality within a data system. Each object is defined by a set of parameters or attributes that dictate the object's behavior, structure, and relationships with other elements in the data environment. For example, objects can be represented by a node, which is a structural element in a database that can contain various data structures such as tables, views, and streams. Similarly, objects can be represented by a table, which represents a collection of related data organized into rows and columns. Columns define the structure of the data, and the rows are data records that adhere to the overall table structure. Objects often exhibit dependencies and relationships with other objects within the data warehouse. For example, a table, and thus, the columns within the table, can be transformations of (and thus dependent on) the data from another table. Transformations are processes in data management that encompass the manipulation, conversion, and/or restructuring of objects from one form to another. For example, a transformation can result in a new table within a node and/or a new column within an existing table, where the new table's data is calculated from the data of the new table's dependencies.

Traditional approaches to managing resources within data warehouses often involve manual intervention and ad-hoc processes, which are prone to errors and inconsistencies. One shortcoming of a manual approach is that, without a structured approach, organizations may struggle to maintain data accuracy and consistency, especially when dealing with large volumes of complex data. Traditional approaches often lack scalability and efficiency, particularly when handling diverse data sources and complex transformation requirements. Manual execution of transformations can be time-consuming and resource-intensive, leading to delays in data processing and analysis. Another shortcoming of a manual approach is that traditional approaches may struggle to handle dependencies and relationships between data objects effectively. In complex data environments, objects often exhibit complex dependencies and relationships that must be carefully managed during transformations to maintain accuracy. A further shortcoming of a manual approach is the limited visibility and traceability of transformation processes in traditional approaches. Organizations may face difficulties in tracking the lineage of transformations, making it challenging to troubleshoot errors. It would therefore be beneficial to have a phased transformation deployment system for transforming objects within data warehouses in order to streamline modifications across the data storage infrastructure.

### BRIEF DESCRIPTION OF THE DRAWINGS

The disclosure may be more completely understood in consideration of the following detailed description of various embodiments of the disclosure in connection with the accompanying drawings, in which:

FIG. 1 is an example graphical user interface representing a linked set of nodes within a data warehouse in accordance with embodiments of the present technology.

FIG. 2 is a block diagram of an example current state of a set of nodes and a desired state of the set of nodes in accordance with embodiments of the present technology.

FIG. 3 is a flow chart of a process to generate a set of add nodes that have been added to the desired state of the set of nodes, a set of remove nodes that have been removed from the current state of the set of nodes, and a set of alter nodes that have been altered between the current state and the desired state of the set of nodes.

FIGS. 4A and 4B are two representations of a set of inter-node transformations to modify the current state of the set of nodes to the desired state of the set of nodes in accordance with embodiments of the present technology.

FIG. 5A is a block diagram of a removal Directed Acyclic Graph (DAG), constructed from the identified set of remove nodes, and the desired state of the set of nodes after executing the removal DAG in accordance with embodiments of the present technology.

FIG. 5B is a block diagram of an alter DAG, constructed from the identified set of alter nodes, and the desired state of the set of nodes after executing the alter DAG in accordance with embodiments of the present technology.

FIG. 5C is a block diagram of an add DAG, constructed from the identified set of add nodes, and the desired state of the set of nodes after executing the add DAG in accordance with embodiments of the present technology.

FIG. 6 is a block diagram of an example current state of a set of columns within a table, such as a table found within a node, and a desired state of the set of columns within the table in accordance with embodiments of the present technology.

FIG. 7 is a flow chart of a process to generate a set of add columns within the table that have been added to the desired state of the set of columns, a set of remove columns within the table that have been removed from the current state of the set of columns, and a set of alter columns within the table that have been altered between the current state and the desired state of the set of columns.

FIGS. 8A and 8B are two representations of a set of intra-table transformations to modify the current state of the set of columns within the table to the desired state of the set of columns within the table in accordance with embodiments of the present technology.

FIG. 9A is a block diagram of a removal Directed Acyclic Graph (DAG), constructed from the identified set of remove columns, and the desired state of the set of columns after executing the removal DAG in accordance with embodiments of the present technology.

FIG. 9B is a block diagram of an alter DAG, constructed from the identified set of alter columns, and the desired state of the set of columns after executing the alter DAG in accordance with embodiments of the present technology.

FIG. 9C is a block diagram of an add DAG, constructed from the identified set of add columns, and the desired state of the set of columns after executing the add DAG in accordance with embodiments of the present technology.

FIG. 10 illustrates a process flow to execute the removal, alter, and add DAGs in order to generate the desired state of the set of objects in accordance with embodiments of the present technology.

FIG. 11 is a block diagram that illustrates an example of a computer system in which at least some operations described herein can be implemented.

### DETAILED DESCRIPTION

The present disclosure relates to a phased transformation deployment system that transforms objects within a data warehouse, both between nodes (i.e., inter-node), and within a node (i.e., intra-node). The phased transformation deployment system manages modifications to structures containing data warehouse objects by systematically executing transformations to achieve a desired state (e.g., structure) of the objects in the data warehouse.

In one aspect, the phased transformation deployment system maintains a current state of objects stored in the data warehouse and receives a desired state of the objects to be achieved through modifications. An object may be a node, which is a structural element in a database that contains various data structures such as tables, views, and streams. Similarly, an object can be a data structure like a table, which represents a collection of data organized into rows and columns. By comparing the current state of an object with the desired state of the object, the system generates a set of transformations, each designed to modify a definition of an object from the object's current state to the desired state. Transformations include defining the structure of the data (e.g., executing data description language or data definition language (DDL)). Examples of DDL operations include adding a column (i.e., introducing a new field to an existing table configured to store data attributes), changing the name of a table (i.e., renames an existing table), and/or modifying constraints on a column (i.e., altering rules that govern data stored in that column). The system uses metadata of each object to compare the current state with the desired state, such as data type, schema definition, or data lineage. The transformations are then separated into predefined groups based on the transformations' similarity, such as removal, alteration, and addition. The system prioritizes transformations within each predefined group by generating deployment phases based on dependencies between the transformations. Each deployment phase modifies the current state of the corresponding object to achieve a desired state of the object. The system can use directed acyclic graphs to represent the deployment phases. The system modifies the current state of the set of objects in accordance with the deployment phases to generate the desired state of the objects. The system verifies the completion of previous transformations before implementing subsequent transformations. The system can use a caching system to store the current state of objects in the data warehouse.

In another aspect, the system provides a user interface that receives user input associated with predefined groups of transformations, enabling users to customize and direct the implementation of transformations according to specific requirements. For instance, users select predefined groups of transformations, such as removal, alteration, or addition, and determine the order in which they deploy the deployment phases of the transformations within each predefined group. In another example, the user input specifies commands (e.g., Structured Query Language (SQL) commands) configured to manually assign particular transformations to a particular group.

In yet another aspect, the system executes SQL commands/statements to perform the transformations on the set of objects stored in the data warehouse. The transformations include changing configuration options on materializations, such as changing data types, nullability, descriptions and other structural properties.

Various features of the phased transformation deployment system introduced above will now be described in further detail. The following description provides specific details for a thorough understanding and enabling description of these examples. One skilled in the relevant art will understand, however, that the technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used herein is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

### Phased Transformation Deployment System

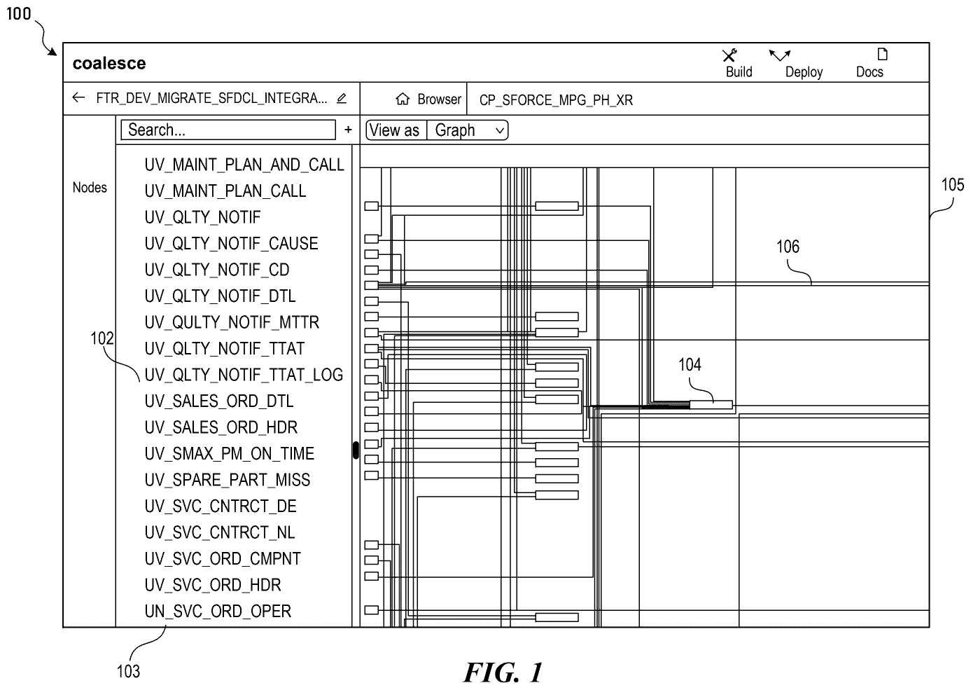

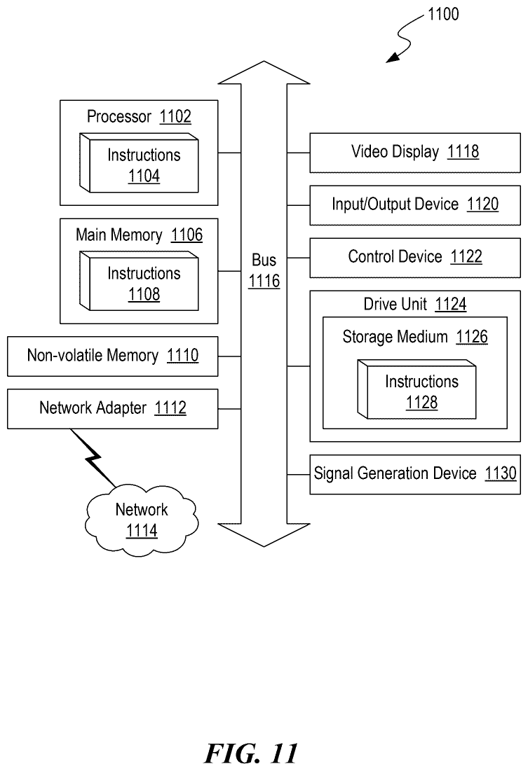

FIG. 1 is an example graphical user interface 100 representing a linked set of nodes within a data warehouse in accordance with embodiments of the present technology. Data warehouses, such as warehouses offered by Snowflake™, Amazon Redshift™, Microsoft Azure™ or others are increasingly used by individuals, companies, and government agencies to conveniently store data in ways that facilitate use, manipulation, and analysis. Graphical user interface 100 includes nodes 102, node window 103, graphical connectors 104, graph window 105, and edges 106. Graphical user interface 100 is implemented using components of example computer system 1100 illustrated and described in more detail with reference to FIG. 11.

The graphical user interface 100 provides a list of nodes 102 in a node window 103 and a graphical representation of connections between those nodes in a graph window 105. Each node 102 corresponds to a materialization stored within the data warehouse. The graphical representation can be a hierarchical tree structure representing the interconnected nodes 102. Each node 102 in the tree represents a materialization, with parent-child relationships indicating dependencies between nodes. Each materialization can include various object management structures such as tables, tasks, and/or streams, and include the logic necessary for handling specific data operations.

For example, a table materialization contains details such as the table's location, name, and/or columns. A task materialization can delineate specific data processing tasks or workflows for data transformation, extraction, or loading processes. Further, a stream materialization can represent data streams responsible for real-time data ingestion and/or processing. Additionally, a materialization represents other object management structures within the data warehouse ecosystem, such as views, which are virtual tables generated dynamically from one or more underlying tables or queries, schemas, and/or other structures that define the organization, layout, and relationships of database objects within a database.

Within the graph window 105 and the depicted node graph, graphical connectors 104 and edges 106 illustrate the dependent structure of the linked nodes. The connectors 104 show which nodes are linked to, or depend from, other nodes. The edges 106 between different nodes represent the complex interdependencies between different nodes by visually conveying the relationships of the data between various materializations. For example, a table materialization contains information regarding table structure, schema, and data storage details, while also accommodating dependencies relevant to data streams or tasks. Textual annotations or graphical overlays can be incorporated into the graphical user interface 100 to provide information about the dependencies between nodes. For example, when users hover over or click on a node, a graphical overlay displays relevant information about the node's dependencies (e.g., types of connections, nature of the relationships, associated materializations/nodes).

Within a data warehouse, materializations are often not isolated entities but instead have interdependencies that span across various nodes. For example, a table materialization relies on upstream data streams for input, while downstream tasks depend on the output generated by the table. Furthermore, cascading dependencies can occur, where changes made to one materialization propagate across multiple interconnected nodes, leading to a ripple effect throughout the data warehouse. The complexity of these dependencies renders manual changes and management of the data warehouse environment virtually impossible. Attempting to navigate and/or modify the intricate network of connections manually is not only labor-intensive but also prone to errors and inconsistencies. With numerous materializations and interdependencies to consider, even minor modifications can have far-reaching implications and potentially disrupt data workflows and operations. Additionally, as the data warehouse evolves and scales in complexity, the challenge of manually tracking and managing dependencies becomes increasingly challenging, exacerbating the risk of configuration drift and data inconsistencies.

### Examples of Inter-Node Phased Transformations

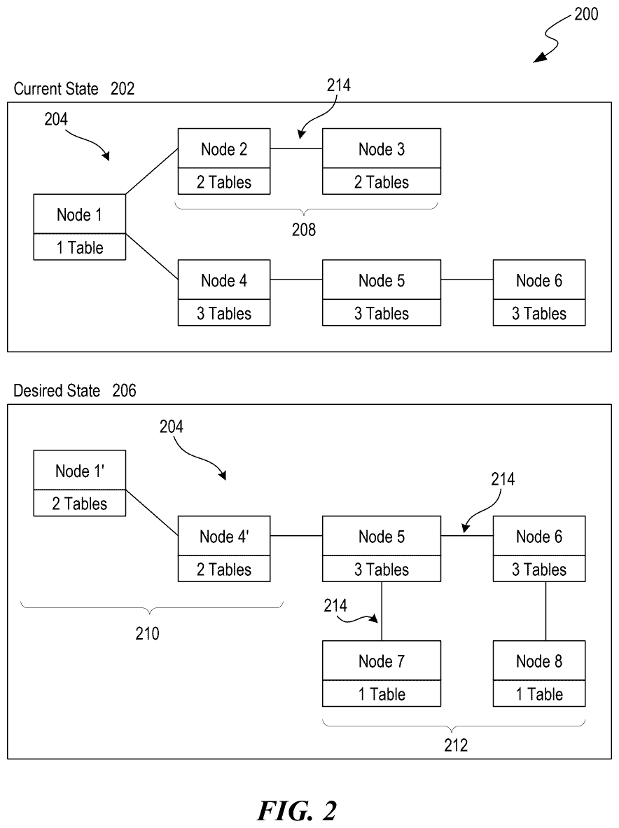

FIG. 2 is a block diagram 200 of an example current state 202 of a set of nodes and a desired state 206 of the set of nodes in accordance with embodiments of the present technology. The current state 202 refers to the existing condition or configuration of nodes 204 within the data warehouse at a specific point in time. The nodes 204 contain various data structures, such as tables, views, and streams. Data structures can include columns, rows, indexes, views, or other database entities that store and organize data within the data warehouse. The nodes 204 serve as containers for data or logic, enabling storage, organization, and manipulation of information within the data warehouse. The condition or configuration of the nodes 204 includes the stored data structure, content, and relationships. For example, a node 204 can be a particular node in the data warehouse, where the node represents a structured collection of tables further organized into rows and columns. Each column within the table corresponds to a specific attribute or field, while each row represents a record or entry. A column within a table defines a single attribute or characteristic of the data stored within the table. Each column in the table corresponds to a specific attribute or property, such as the data's name, type, size, and creation date. In FIG. 2, for example, the current state 202 depicts six nodes 204 (nodes 1 through 6). Node 1 contains one table, node 2 contains two tables, node 3 contains two tables, node 4 contains three tables, node 5 contains three tables, and node 6 contains three tables. The six nodes 204 depicted in FIG. 2 are merely representative of different node definitions that may be included in the data warehouse. For example, a node can contain any combination of and any number of various data structures, such as a table, view, stream, and so forth.

In some implementations, the current state 202 can be represented using a hierarchical data structure, such as a tree or JavaScript Object Notation (JSON) document. Each node or element in the structure corresponds to a node 204 within the data warehouse, with nested elements representing attributes and configurations. For example, a JSON document can contain nested key-value pairs for each node 204, describing the node's 204 name, type, and other relevant details. The current state 202 can be visualized through graphical representations, such as entity-relationship diagrams or other data flow diagrams.

The desired state 206 represents the desired or intended configuration of objects (i.e., nodes 204) within the data warehouse after undergoing inter-node transformations. The desired state 206 defines the target outcome or objective that the data warehouse should achieve by applying inter-node transformations. The desired state 206 is defined by specifying the desired structure, content, and properties of each node 204 remaining within the warehouse (including nodes to be added in the transformation(s)). Once the desired state 206 has been defined, the desired state 206 can be expressed using declarative languages or configuration files. For instance, SQL statements define the desired structure and properties of nodes (e.g., number of tables, views, or streams within the node) within the warehouse based on the desired state 206. The SQL statements can specify attributes such as data types, constraints, and/or relationships between objects.

In some implementations, the desired state 206 is dynamically generated based on jurisdictional/organizational requirements or user input. For example, predefined business rules or transformation logic can calculate the desired attributes and configurations of objects in real-time, taking into account factors such as data quality, performance, and compliance requirements. For example, if a retail company aims to update the product catalog in the data warehouse to reflect new inventory items and pricing changes, the system can automatically calculate the desired state 206 based on predefined rules that incorporate factors such as product availability, pricing strategies, and seasonal trends. Dynamically generating the desired state 206 ensures that the product catalog is always up-to-date and accurately reflects the current state of the business.

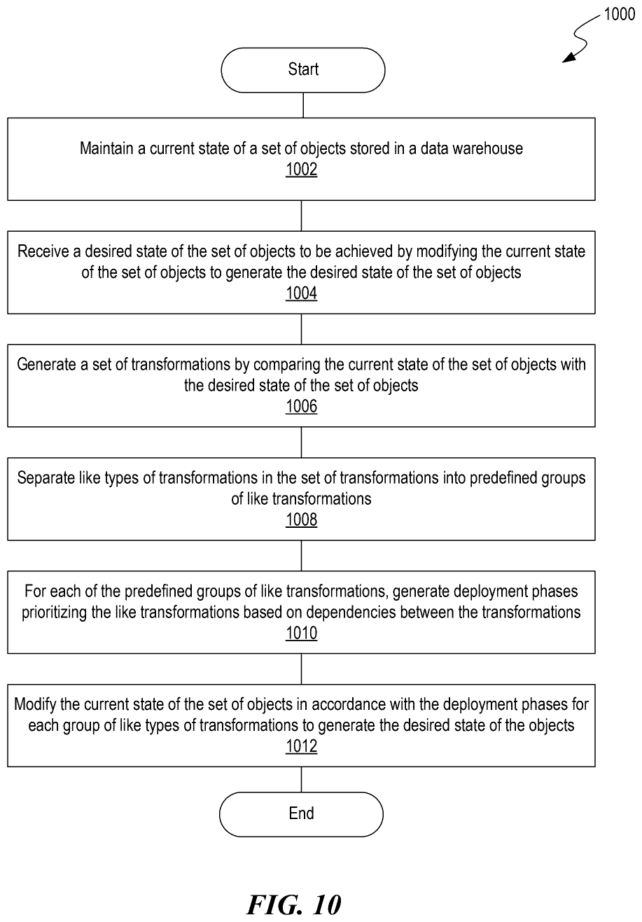

The current state 202 is transformed into the desired state 206 by adding, removing, and/or altering certain nodes 204 within the data warehouse. For example, certain nodes 204 can be altered to change the object's structure, content, and/or properties (e.g., node 1 and node 4 in FIG. 2). Methods of transforming the current state 202 into the desired state 206 are discussed with reference to FIG. 10.

A removed node is a node within the data warehouse that has been deleted or removed from the database. Once removed, the removed node is inaccessible and non-existent within the database environment. For example, a user may desire to remove a node when the node is obsolete or contains redundant data/objects. In FIG. 2, the two nodes 208 representing node 2 and node 3 have been removed since the columns are absent from the desired state 206, but appear in the current state 202. An altered node refers to a node within the data warehouse that has undergone alteration or transformation from its original state. The alteration includes changes to the structure, content, or properties of the node. For example, two nodes 210 are altered in FIG. 2. A first altered node 210a in FIG. 2 is an altered node since the first node 210a contains one table in the current state 202, but contains two tables in the desired state 206. Similarly, a second altered node 210b reflects an altered object because the number of structures within the second altered node 210b changed from three tables in the current state 202 to two tables in the desired state 206. An added node refers to a new node that has been introduced or appended to the data warehouse. The addition could involve creating new database entities or new structures between existing database entities (e.g., tables, views, and/or streams) to accommodate additional data or functionality requirements. For example, a user can add a new view to a node associated with objects of the data warehouse. In FIG. 2, node 7 and node 8 are added nodes 212 because the nodes appear in the desired state 206, but do not appear in the current state 202.

In FIG. 2, dependencies 214 between nodes are identified by lines connecting two nodes to reflect that one node is associated with or coupled to another node. Dependencies 214 between nodes 204 refer to relationships and connections that dictate how modifications propagate across the data warehouse. Dependencies 214 can determine the order, sequence, and impact of changes applied to individual nodes 204 within the data warehouse and ensure coherence and consistency in the overall database structure and functionality. Dependencies 214 include associations such as parent-child associations, reference constraints, foreign key dependencies, and/or data dependencies. For example, if a node in the data warehouse serves as a parent entity, and multiple related nodes act as child entities linked through foreign key constraints, dependencies 214 exist between the parent and child nodes, meaning that modifications to the parent node may necessitate corresponding changes or cascading effects on the child nodes to maintain referential integrity. Dependencies 214 can extend beyond structural relationships to also include functional and logical dependencies that govern the behavior within the data warehouse. For example, dependencies 214 arise between stored procedures, views, or queries, where modifications to one component necessitate adjustments to related components to ensure consistency and coherence in data processing and retrieval.

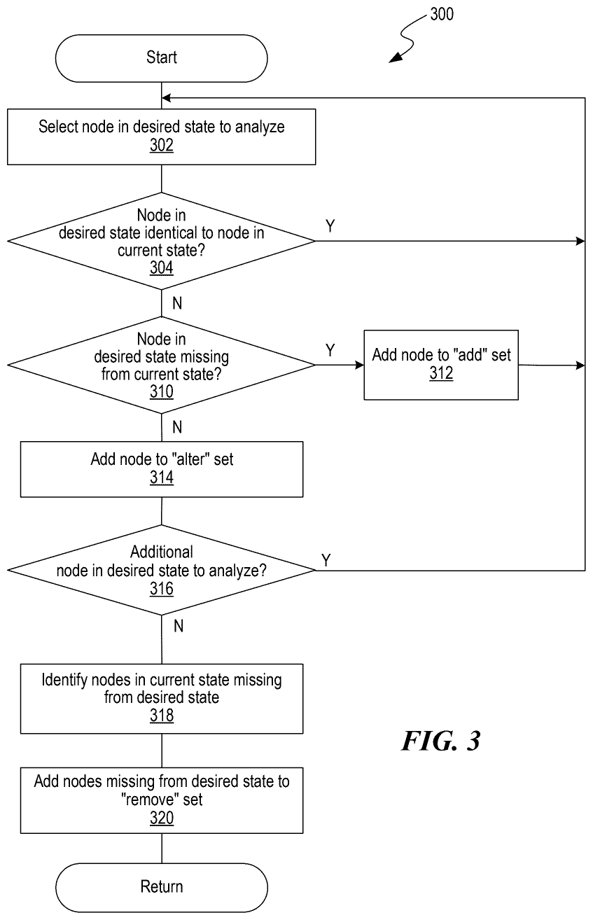

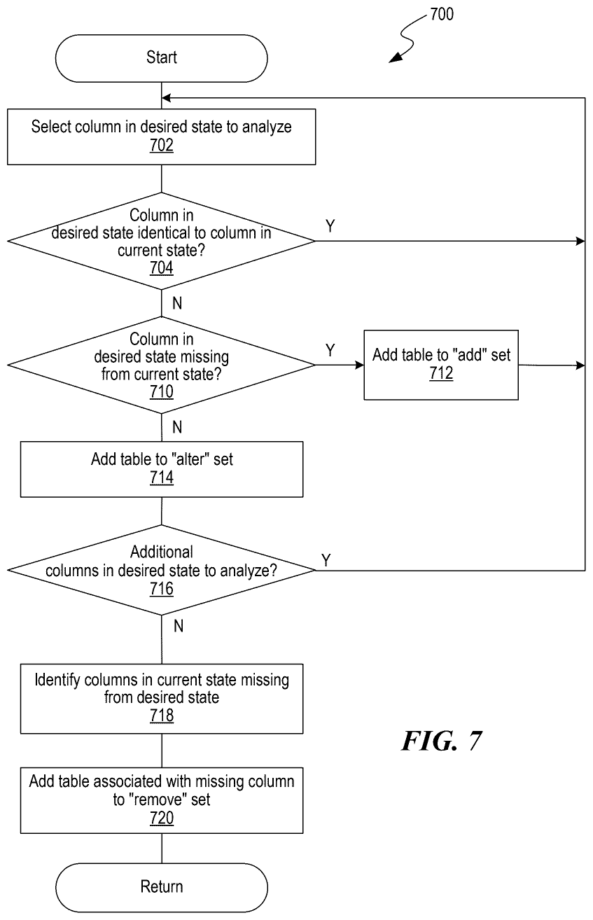

FIG. 3 is a flow chart of a process to generate a set of add nodes that have been added to the desired state of the set of nodes, a set of remove nodes that have been removed from the current state of the set of nodes, and a set of alter nodes that have been altered between the current state and the desired state of the set of nodes. The sets encapsulate the changes between the current state (e.g., current state 202 in FIG. 2) and the desired state (e.g., desired state 206 in FIG. 2) of the set of nodes within the data warehouse. Although FIG. 3 is tailored to operate on a defined node within a data warehouse, it will be appreciated that other similar characterization processes could be utilized to analyze other data structures stored within the data warehouse (e.g., tables, as discussed with reference to FIG. 7).

At step 302, the system selects a node in a desired state to analyze, beginning the characterization process 300. In some implementations, the system selects the node through automated scripts or algorithms designed to iterate through the dataset systematically. The algorithms traverse the dataset, identifying each node in the desired state sequentially.

At step 304, the system evaluates whether the selected node in the desired state matches its counterpart in the current state. The evaluation compares the attributes, properties, and configurations of the node as the node exists in both states to identify any disparities or differences that indicate a modification. Specifically, the system can examine factors such as the node name, node contents, size constraints, and other metadata attributes to assess whether the node has undergone any changes. The system can query database metadata, retrieve schema information, and perform attribute-level comparisons to ascertain the extent of modifications, if any, applied to the node. Further methods of comparing the current state of the node and the desired state of the node are discussed with reference to FIG. 7 and FIG. 10. If no disparity is detected, meaning that the node remains unchanged between the current and desired states, the process returns to step 302 to analyze another node.

If the selected node is new or changed in the desired state, processing continues to step 310. At step 310, the system assesses whether the node in the desired state is missing from the current state, which implies that the node has been added (e.g., an added node 212 with reference to FIG. 2). If the analyzed node is absent from the current state, step 312 adds the node to the “add” set, signifying its inclusion in the desired state while not existing in the current state. For example, if the table in FIG. 2 were processed by the characterization process 300, the objects associated with node 7 and node 8 are added to the “add” set since the objects representing those nodes are present in the desired state 206, but absent in the current state 202.

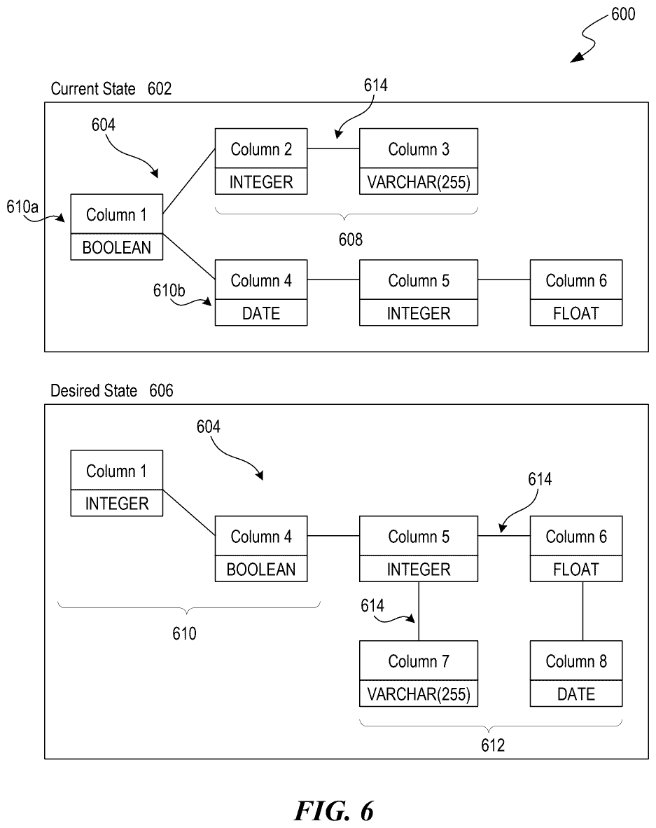

If the node is not determined to have been added to the desired state in step 310, step 314 concludes that the node has been altered between the two states since the node in the desired state is not identical to the node in the current state, but the node has not been added in the desired state (e.g., the altered nodes 210 with reference to FIG. 2). Consequently, the node is added to the “alter” set, indicating changes in the attributes, structure, or properties of the node. For example, if the nodes in FIG. 2 were processed by the characterization process 300, the objects associated with node 1 and node 4 are added to the “alter” set since the objects representing those nodes are present in both the desired state 206 and the current state 202, but have a different number of data structures (e.g., tables) in each. Methods of transforming altered nodes are discussed in further detail with reference to FIGS. 6-9.

At step 316, the system checks for additional nodes in the desired state to analyze. If further nodes are present, the process loops back to step 302, repeating the characterization procedure for each node in the desired state. The iterative loop continues until all nodes in the desired state have been analyzed.

Once the nodes of the desired state have been analyzed, the system still needs to determine if any nodes in the current state have been removed and are therefore missing in the desired state. At step 318, the system identifies any nodes in the current state having no counterparts in the desired state, meaning that those nodes have been removed from the current state (e.g., the removed objects 208 with reference to FIG. 2). If one or more nodes in the current state are absent from the desired state, at step 320 the system adds the corresponding nodes(s) to the “remove” set, noting the exclusion from the desired state compared to the current state. For example, if the table in FIG. 2 were processed by the characterization process 300, the objects associated with node 2 and node 3 would be added to the “remove” set since the objects representing those nodes are absent from the desired state 206, but appear in the current state 202.

It will be appreciated that the characterization process 300 continues until all nodes have been assessed for modifications. By systematically traversing through the dataset and evaluating each node individually, the system ensures that all modifications between the current state and the desired state are identified.

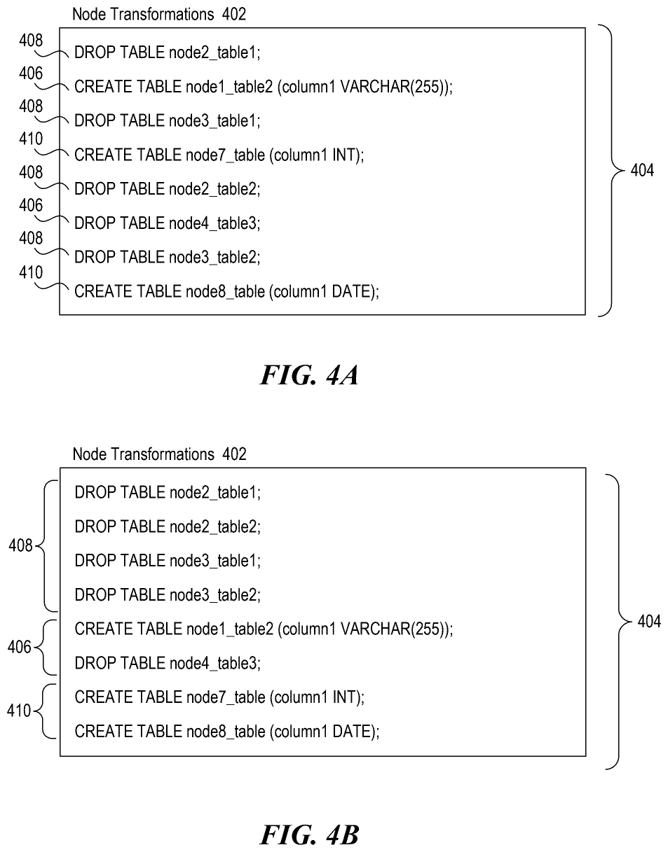

FIGS. 4A and 4B are two representations of a set of inter-node transformations to modify the current state of the set of nodes to the desired state of the set of nodes in accordance with embodiments of the present technology. The particular inter-node transformations 402 depicted in FIGS. 4A and 4B are the inter-node transformations necessary to modify the node depicted in FIG. 2 from the current state 202 to the desired state 206.

The set of inter-node transformations 402 can be formatted in a Structured Query Language (SQL) format. The system uses SQL commands and syntax to define and execute the desired modifications within the data warehouse. Each inter-node transformation within the set is represented by SQL statements that correspond to specific actions, such as adding, removing, or altering objects/data structures containing objects within the dataset. For example, the SQL command “ALTER TABLE node1_table ALTER COLUMN column_name SET DATA TYPE VARCHAR (255);” is used to modify the structure of existing nodes (i.e., adding a column to a table within a node), while “DROP TABLE node2_table1; DROP TABLE node2_table2;” is used to remove unwanted structures from a node.

In FIG. 4A, the SQL format comprises inter-node transformations 402 for the node structure (e.g., “ALTER TABLE”). The inter-node transformations 402 encompass a series of commands 404, each serving a piecemeal function in transforming the current state of the node to the desired state of the node.

The commands 404 include altering commands 406, such as “ALTER TABLE node1_table ALTER COLUMN column_name SET DATA TYPE VARCHAR (255);” and “ALTER TABLE node4_table ADD COLUMN new_column_name FLOAT;.” The commands facilitate alterations to specific nodes (e.g., nodes 1 and 2), changing structures within the node (e.g., creating or deleting a table, view and/or stream within the node) to meet the requirements of the desired state. The altering commands 406 are categorized as such because the node remains extant. For example, node 4 retains two tables subsequent to the deletion of table3, so the node's existence is preserved. Commands 404 also include removal commands 408 that effectively remove a node altogether (e.g., “DROP TABLE node2_table1;” “DROP TABLE node2_table2;” “DROP TABLE node3_table1;” and “DROP TABLE node3_table2;”). The removal commands 408 instruct the system to remove designated tables (e.g., both tables from node 2 and both tables from node 3) from the corresponding node structure, discarding the nodes from the current state to achieve alignment with the desired state. Commands 404 include add commands 410 (e.g., “CREATE TABLE node7_table (column1 INT);” “CREATE TABLE node8_table (column1 DATE);”). The add commands 410 add new nodes (e.g., nodes 7 and 8) by instantiating a new schema, introducing new dimensions of data or functionality to corresponding objects. By adding new nodes with predefined data types and constraints, organizations can adapt the organization's data infrastructure to accommodate evolving business requirements and/or analytical needs.

In FIG. 4B, the inter-node transformations 402 in the list have been sorted so that like commands have been grouped together. In the depicted list, the inter-node transformations are structured according to a predetermined sequence of operations, with drop operations listed first, alter operations listed second, and add operations listed third. While the commands remain identical to those in FIG. 4A, the sequencing of inter-node transformations in FIG. 4B is used to mitigate dependency problems commonly encountered in transformation processes. That is, by processing drop operations before alter and add operations, and alter operations before add operations, the system encounters fewer dependency problems compared to processing the inter-node transformations in the order depicted in FIG. 4A.

Beginning with the drop commands causes nodes to be removed first from the data warehouse. Following the drop commands, the sequence progresses to alter commands and eliminates dependencies associated with the dropped nodes. By removing dependencies before making alterations or additions, the transformation process becomes less prone to conflicts or disruptions stemming from dependencies on nodes slated for removal, which may be outdated or unnecessary components. The alteration commands are then executed, ensuring that alterations to existing nodes occur in a context where dependencies have been accounted for and potential conflicts have been minimized. Finally, add commands are executed by the system to add new nodes to the data warehouse. By sequencing additions after the deletion and alteration of nodes, organizations can focus on refining and optimizing the structure, content, or properties of the dataset without being encumbered by dependencies or conflicts with other elements. The sequential approach allows alterations to be made with fewer dependencies, reducing the likelihood of dependency-related errors or inconsistencies.

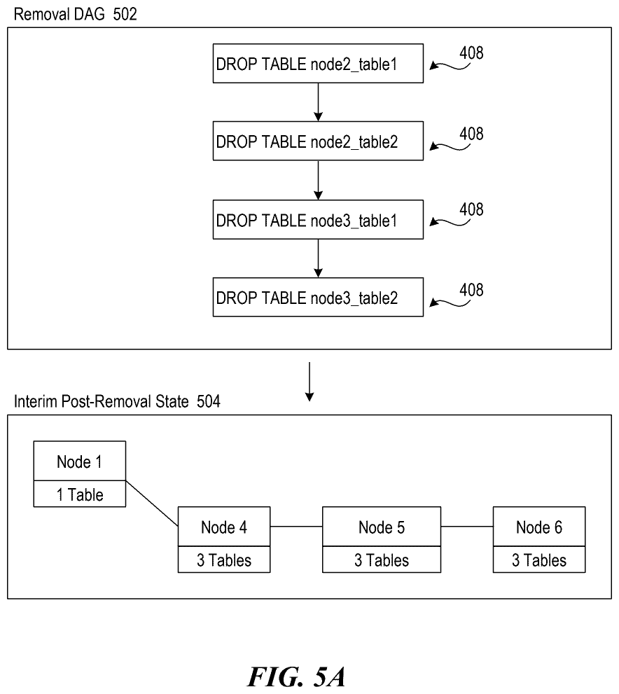

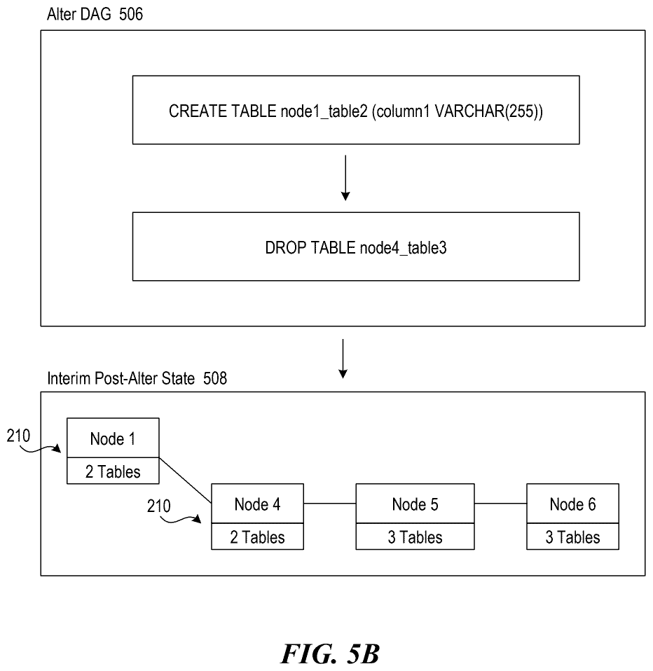

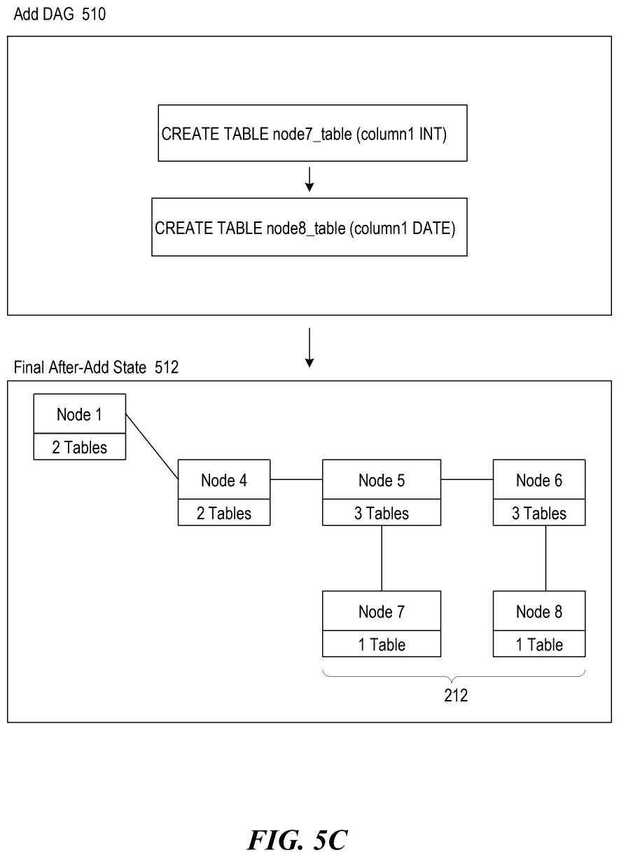

Once inter-node transformations have been grouped by like operations, they are executed in a defined order. FIGS. 5A, 5B, and 5C depict techniques to sequence the execution of drop, alter, and add operations. FIG. 5A is a block diagram of a removal Directed Acyclic Graph (DAG) 502, constructed from an identified set of remove nodes 208 and corresponding removal commands 408, and the desired state of the set of nodes after executing the removal DAG in accordance with embodiments of the present technology. The removal DAG 502 in FIG. 5A corresponds to the removal commands necessary to transition the representative table depicted in FIG. 2 to the desired state 206.

The removal DAG 502 is constructed based on the identified set of removed nodes 208, providing the sequence of removal commands necessary to transition the data warehouse from its current state to the desired state. The removed nodes 208 can contain or reference to tables, views, streams, and/or other entities in the data warehouse deemed obsolete, redundant, or no longer necessary for the operation of the data warehouse. Methods of ordering a removal DAG are discussed with reference to FIG. 10.

The removal DAG 502 contains four removal commands 408 in FIGS. 4A and 4B, namely “DROP TABLE node2_table1;” “DROP TABLE node2_table2;” “DROP TABLE node3_table1;” and “DROP TABLE node3_table2;.” The removal commands 408 instruct the system to discard specified nodes (e.g., nodes 2 and 3) from the data warehouse. By structuring the removal DAG 502 as a Directed Acyclic Graph (DAG), the system ensures that the removal commands are executed in a specific order that avoids circular dependencies or conflicts between removal operations. A DAG is a data structure consisting of vertices (nodes) and directed edges that connect these vertices. In a DAG, each edge has a direction, indicating a relationship from one vertex to another. A DAG does not contain cycles, meaning there is no way to traverse the graph starting from one vertex and following the edges to return to the same vertex without retracing any edges. Each node in the DAG represents a specific operation or task, while the edges denote the direction between the operations. For example, if operation A (e.g., “DROP TABLE node2_table1;”) must be completed before operation B (e.g., “DROP TABLE node2_table2;”) can start, there will be a directed edge from node A to node B in the DAG. Each removed object corresponds to a node in the removal DAG, and there are directed edges between nodes to represent dependencies between removal operations.

Upon execution of the removal DAG 502, the interim post-removal state 504 reflects the data warehouse state. The system traverses the removal DAG in topological order, ensuring that removal operations are performed in the correct sequence to avoid dependency issues (e.g., traversing in the direction of the directed edges between nodes). The removal operations are executed in such a way that if one node (or structures within a node) depends on another, the dependent node is removed only after the node it depends on has been removed. As the removal operations are executed, the system updates the data warehouse state accordingly. For each removal command in the removal DAG, the corresponding node is removed from the data warehouse, and the system updates the database schema to reflect the removal of the node and any associated metadata. In FIG. 5A, as a consequence of the removal operations, only nodes 1, 4, 5, and 6 remain within the data warehouse. Nodes 2 and 3 are removed from the data warehouse in accordance with the removal DAG 502.

In some implementations, the execution of the removal DAG includes logging each removal operation for auditing purposes and/or performing validation checks to ensure that the removal operations do not violate any predefined constraints or dependencies in the data warehouse. For example, the validation checks include examining the impact of the removal on other objects within the data warehouse and verifying that the removal does not violate any dependencies, established rules, or guidelines.

FIG. 5B is a block diagram of an alter DAG 506, constructed from the identified set of altered nodes 210 and corresponding set of alter commands 406, and the desired state of the set of nodes after executing the alter DAG in accordance with embodiments of the present technology. The alter DAG 506 in FIG. 5B corresponds to the alter commands necessary to transition the representative table depicted in FIG. 2 to the desired state 206. Changes within a node can further be processed in accordance with methods discussed in FIGS. 6-9. For example, changes within a table, such as altering column data types, adding new columns, or deleting existing ones, can be systematically managed using phased transformations to maintain the functionality of the data structures (e.g., the node) while accommodating updates to structures within the node (e.g., a table within a node).

The alter DAG 506 is constructed based on the identified set of altered nodes 210, providing the sequence of alter commands 406 necessary to transition the data warehouse from its current state to the desired state in the data warehouse. Examples of alterations include changes to the structure, content, or properties of objects such as columns or tables. Once the alterations to each node has been analyzed, the system organizes the nodes into a sequential order within the alter DAG 506. This sequential order ensures that the alterations are applied in a logical and coherent manner, taking into account any dependencies or relationships between nodes. For example, if an altered node depends on another node for its definition or functionality, the system arranges the inter-node transformation operations accordingly to preserve data consistency. Methods of ordering a alter DAG are discussed with reference to FIG. 10.

The alter DAG 506 contains the alter commands 406 in FIGS. 4A and 4B, namely “CREATE TABLE node1_table2 (column1 VARCHAR (255));” and “DROP TABLE node4_table3;” The alter commands 406 instruct the system to alter specified nodes (e.g., nodes 1 and 4) in the data warehouse's structure. For example, in FIG. 4, node 1 is altered by adding a table, and node 4 is altered by removing a table. Alterations within a table are discussed in further detail with reference to FIGS. 6-9. The alter DAG 506 is constructed in a similar manner to the removal DAG 502 discussed in further detail with reference to FIG. 5A and FIG. 10.

The alter DAG 506 is executed by the system after the removal DAG 502 has been executed. That means that the alter DAG 506 operates on the object state as reflected in the interim post-removal state 504. Upon execution of the alter DAG 506, the data warehouse state and corresponding table is reflected in the interim post-alter state 508. The alter DAG 506 is traversed in a same or similar manner to the removal DAG 502 discussed in further detail with reference to FIG. 5A and FIG. 10. In FIG. 5B, as a consequence of the alteration operations, altered nodes 210 have been modified. Namely, node 1 has changed from containing one table to containing two tables. And node 4 has been altered from containing three tables to containing two tables. Since the removal DAG 502 was executed before the alter DAG 506, nodes 2 and 3 are not present in the data warehouse state since the nodes have been already previously removed.

FIG. 5C is a block diagram of an add DAG 510, constructed from the identified set of add nodes 212 and corresponding add commands 410, and the desired state of the set of nodes after executing the add DAG in accordance with embodiments of the present technology. The add DAG 510 in FIG. 5C corresponds to the addition commands necessary to transition the representative table depicted in FIG. 2 to the desired state 206.

The add DAG 510 is constructed based on the identified set of added nodes 212, providing the sequence of add commands 410 necessary to transition the data warehouse and corresponding table from its current state to the desired state. The added 138737.8002.CS00M168804451.1 nodes 212 include new tables, streams, views, columns, indexes, or other database elements required to accommodate changes in data requirements or business logic. The add DAG 510 contains the add commands 410 in FIGS. 4A and 4B, namely “CREATE TABLE node7_table (column1 INT);” and “CREATE TABLE node8_table (column1 DATE);.” The add commands 410 instruct the system to add specified tables (e.g., node7_table and node8_table) to the corresponding node structures (e.g., node 7 and node 8) in the data warehouse. Methods of ordering an add DAG are discussed with reference to FIG. 10.

The add DAG 510 is executed by the system after the alter DAG 506 has been executed. That means that the add DAG 510 operates on the node state as reflected in the interim post-alter state 508. Upon execution of the add DAG 510 on the executed alter DAG 506, the data warehouse state is reflected in final after-add state 512. The final after-add state 512 corresponds to the desired state 206, since all additions, alterations, and deletions have been made to the node in the current state 202. The add DAG 510 has the same or similar structure to the removal DAG 502 discussed in further detail with reference to FIG. 5A and FIG. 10. As a consequence of the add operations, nodes 1, 4, 5, and 6, 7, and 8 exist within the data warehouse table structure, since nodes 7 and 8 are added to the data warehouse.

### Examples of Intra-Node Phased Transformations

FIG. 6 is a block diagram 600 of an example current state 602 of a set of columns within a node (e.g., nodes 1-8 in FIG. 2) and a desired state 606 of the set of columns within the node in accordance with embodiments of the present technology. The set of columns may reflect, for example, an instance of a table within a node. The current state 602 refers to the existing condition or configuration of columns 604 within the node at a specific point in time. The columns 604 represent discrete units of data or functionality. Although FIG. 6 depicts columns, it will be appreciated that the discrete units of data or functionality might also include rows, indexes, views, or other database entities that store and organize data within the node. The columns 604 serve as containers for data or logic, enabling storage, organization, and manipulation of information within the node. The condition or configuration of the columns 604 includes the stored columns' structure, content, and relationships. Each column within a table corresponds to a specific attribute or field, while each row represents a record or entry. Each column in the table corresponds to a specific data attribute or property, such as the name, type, size, and creation date of the corresponding data. In FIG. 6, for example, the depicted columns 604 define six columns (columns 1 through 6) of a table. Column 1 contains a Boolean value, column 2 an integer value, column 3 a character value, column 4 a date value, column 5 an integer value, and column 6 a float value. The six columns depicted in FIG. 6 are merely representative of different column definitions that may be included in a table.

The desired state 606 represents the desired or intended configuration of the table within the node after undergoing intra-node transformations. The desired state 606 defines the target outcome or objective that the node should achieve by applying intra-node transformations. The desired state 606 is defined by specifying the desired structure, content, and properties of each column 604 remaining within the warehouse (including columns to be added in the intra-node transformation(s)). Once the desired state 606 has been defined, the desired state 606 can be expressed using declarative languages or configuration files. For instance, SQL (Structured Query Language) statements define the desired structure and properties of tables and columns within the node based on the desired state 606. The SQL statements can specify attributes such as data types, constraints, and/or relationships between columns. The current state 602 is transformed into the desired state 606 by adding, removing, and/or altering certain columns within the node. For example, certain columns can be altered to change the column's structure, content, and/or properties. Methods of transforming the current state 602 into the desired state 606 are discussed with reference to FIG. 10.

A removed column is a column within the node that has been deleted or removed from the database. Once removed, the removed column is inaccessible and non-existent within the database environment. For example, a user may desire to remove a column when the column is obsolete or contains redundant data. In FIG. 6, the two columns 608 representing column 2 and column 3 have been removed since the columns are absent from the desired state 606, but appear in the current state 602. An altered column refers to a column within the node that has undergone alteration or transformation from its original state. The alteration includes changes to the structure, content, or properties of the columns. For example, two columns 610 are altered in FIG. 6. A first column 610a in FIG. 6 is an altered column since column 1 appears as a “BOOLEAN” column in the current state 602, but appears as an “INTEGER” column in the desired state 606. And a second column 610b reflects an altered column because the datatype of column 4 has changed from “DATE” to “BOOLEAN” in the desired state 606. An added column refers to a new column that has been introduced or appended to the node. The addition could involve creating new columns or other database entities to accommodate additional data or functionality requirements. For example, a user can add a new column to a table associated with a new attribute of the node. In FIG. 6, column 7 and column 8 are added columns 612 because the columns appear in the desired state 606, but do not appear in the current state 602.

In FIG. 6, dependencies 614 between columns are identified by lines connecting two columns to reflect that one column is associated with or coupled to another column. Dependencies 614 between columns 604 refer to relationships and connections that dictate how modifications propagate across the node, similar to dependencies 314 in FIG. 3. The dependencies between the columns can reflect the structure of the corresponding table in which the columns are located.

FIG. 7 is a flow chart of a process 700 to generate a set of add columns within the node that have been added to the desired state of the set of columns, a set of remove columns that have been removed from the current state of the set of columns, and a set of alter columns that have been altered between the current state and the desired state of the set of columns. The sets encapsulate the changes between the current state and the desired state of the set of columns within the node. Although FIG. 7 is tailored to operate on a defined table within a node, it will be appreciated that other similar characterization processes could be utilized to analyze other data structures stored within the node.

At step 702, the system selects a column in a desired state to analyze, beginning the characterization process 700. In some implementations, the system selects the column through automated scripts or algorithms designed to iterate through the dataset systematically. The algorithms traverse the dataset, identifying each column in the desired state sequentially.

At step 704, the system evaluates whether the selected column in the desired state matches its counterpart in the current state. The evaluation compares the attributes, properties, and configurations of the column as the column exists in both states to identify any disparities or differences that indicate a modification. Specifically, the system can examine factors such as the column name, data type, size constraints, and other metadata attributes to assess whether the column has undergone any changes. The system can query database metadata, retrieve schema information, and perform attribute-level comparisons to ascertain the extent of modifications, if any, applied to the column. Further methods of comparing the current state of the column and the desired state of the column are discussed with reference to FIG. 10. If no disparity is detected, meaning that the column remains unchanged between the current and desired states, the process returns to step 702 to analyze another column.

If the selected column is new or changed in the desired state, processing continues to step 710. At step 710, the system assesses whether the column in the desired state is missing from the current state, which implies that the column has been added (e.g., an added column 612 with reference to FIG. 6). If the analyzed column is absent from the current state, step 712 adds the column to the “add” set, signifying its inclusion in the desired state while not existing in the current state. For example, if the table in FIG. 6 were processed by the characterization process 700, the columns associated with column 7 and column 8 are added to the “add” set since the columns are present in the desired state 606, but absent in the current state 602.

If the column is not determined to have been added to the desired state in step 710, step 714 concludes that the column has been altered between the two states since the column in the desired state is not identical to the column in the current state, but the column has not been added in the desired state (e.g., the altered columns 609 or 610 with reference to FIG. 6). Consequently, the column is added to the “alter” set, indicating changes in the attributes, structure, or properties of the column. For example, if the table in FIG. 6 were processed by the characterization process 700, the columns associated with column 1 and column 4 are added to the “alter” set since the columns are present in both the desired state 606 and the current state 602, but have a different datatype in each (e.g., column 1 has a datatype “BOOLEAN” in current state 602, but datatype “INTEGER” in desired state 606).

At step 716, the system checks for additional columns in the desired state to analyze. If further columns are present, the process loops back to step 702, repeating the characterization procedure for each column in the desired state. The iterative loop continues until all columns in the desired state have been analyzed.

Once the columns of the desired state have been analyzed, the system still needs to determine if any columns in the current state have been removed and are therefore missing in the desired state. At step 718, the system identifies any columns in the current state having no counterparts in the desired state, meaning that those columns have been removed from the current state (e.g., the removed columns 608 with reference to FIG. 6). If one or more columns in the current state are absent from the desired state, at step 720 the system adds the corresponding column(s) to the “remove” set, noting the exclusion from the desired state compared to the current state. For example, if the table in FIG. 6 were processed by the characterization process 700, the columns associated with column 2 and column 3 would be added to the “remove” set since the columns are absent from the desired state 606, but appear in the current state 602.

It will be appreciated that the characterization process 700 continues until all columns have been assessed for modifications. By systematically traversing through the dataset and evaluating each column individually, the system ensures that all modifications between the current state and the desired state are identified.

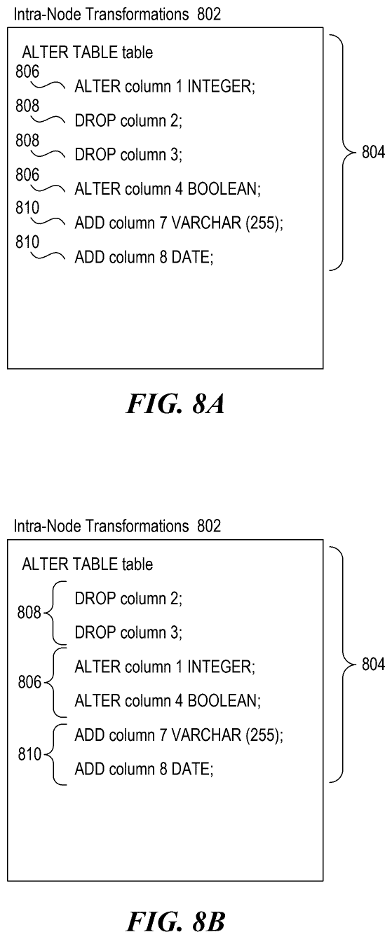

FIGS. 8A and 8B are two representations of a set of intra-node transformations 802 to modify the current state of a set of columns within the node to the desired state of the set of columns in accordance with embodiments of the present technology. The particular intra-node transformations 802 depicted in FIGS. 8A and 8B are the intra-node transformations necessary to modify the table depicted in FIG. 6 from the current state 602 to the desired state 606.

The set of intra-node transformations 802 can be formatted in a Structured Query Language (SQL) format. The system uses SQL commands and syntax to define and execute the desired modifications within the node. Each intra-node transformation within the set is represented by SQL statements that correspond to specific actions, such as adding, removing, or altering columns within the dataset. For example, the SQL command “ALTER TABLE” is used to modify the structure of existing tables, while “DROP COLUMN” is used to remove unwanted columns from the dataset.

In FIG. 8A, the SQL format comprises intra-node transformations 802 for the table structure (e.g., “ALTER TABLE”). The intra-node transformations 802 encompass a series of commands 804, each serving a piecemeal function in transforming the current state of the columns to the desired state of the columns.

The commands 804 include altering commands 806, such as “ALTER column 1 INTEGER” and “ALTER column 2 BOOLEAN.” The commands facilitate alterations to specific columns (e.g., columns 1 and 2) within the table, changing the columns' data types and/or properties to meet the requirements of the desired state. Commands 804 also include removal commands 808 (e.g., “DROP column 2” and “DROP column 3”). The removal commands 808 instruct the system to remove designated columns (e.g., columns 2 and 3) from the table structure, discarding the columns from the current state to achieve alignment with the desired state. Commands 804 include add commands 810 (e.g., “ADD column 7 VARCHAR (655)” and “ADD column 8 DATE”). The add commands 810 add new columns (e.g., columns 7 and 8) to the table, introducing new dimensions of data or functionality. By adding new columns with predefined data types and constraints, organizations can adapt the organization's data infrastructure to accommodate evolving business requirements and/or analytical needs.

In FIG. 8B, the intra-node transformations 802 in the list have been sorted so that like commands have been grouped together. In the depicted list, the intra-node transformations are structured according to a predetermined sequence of operations, with drop operations listed first, alter operations listed second, and add operations listed third. While the commands remain identical to those in FIG. 8A, the sequencing of intra-node transformations in FIG. 8B is used to mitigate dependency problems commonly encountered in transformation processes. That is, by processing drop operations before alter and add operations, and alter operations before add operations, the system encounters fewer dependency problems compared to processing the intra-node transformations in the order depicted in FIG. 8A.

Beginning with the drop commands causes elements to be removed first from the node. Following the drop commands, the sequence progresses to alter commands and eliminates dependencies associated with the dropped columns. By removing dependencies before making alterations or additions, the transformation process becomes less prone to conflicts or disruptions stemming from dependencies on columns slated for removal, which may be outdated or unnecessary components. The alteration commands are then executed after removals, ensuring that alterations to existing columns occur in a context where dependencies have been accounted for and potential conflicts have been minimized. Finally, add commands are executed by the system to add elements to the node. By sequencing additions after the deletion and alteration of columns, organizations can focus on refining and optimizing the structure, content, or properties of the dataset without being encumbered by dependencies or conflicts with other elements. The sequential approach allows alterations to be made with fewer dependencies, reducing the likelihood of dependency-related errors or inconsistencies.

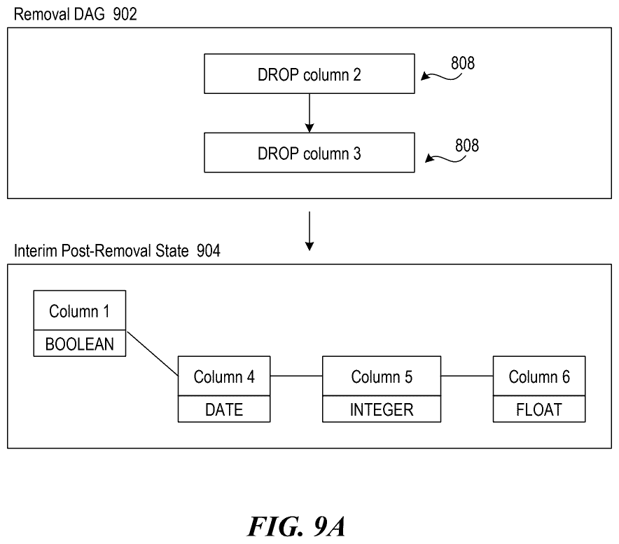

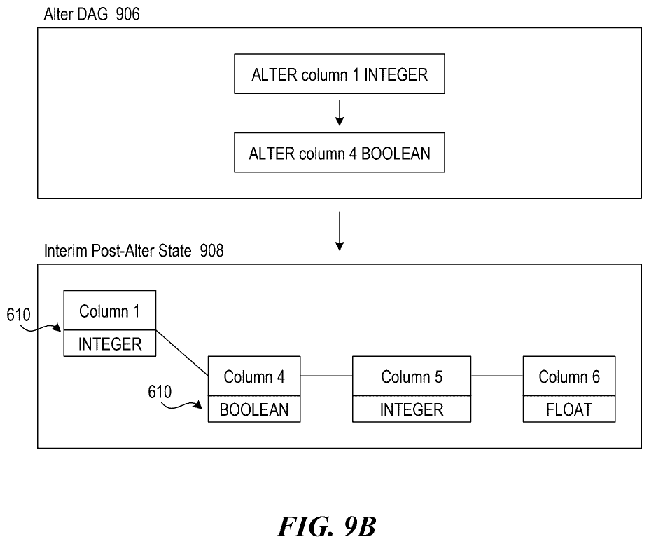

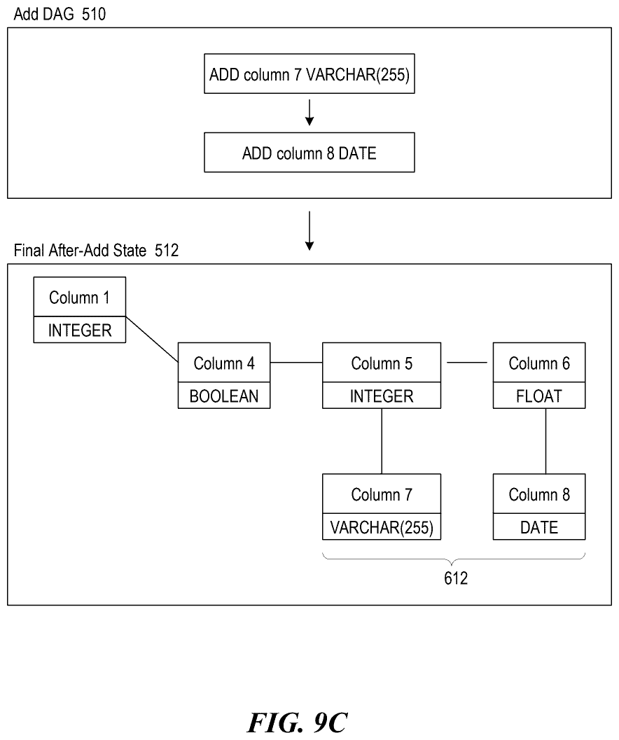

Once transformations (e.g., intra-node transformations 802) have been grouped by like operations, they are executed in a defined order. FIGS. 9A, 9B, and 9C depict techniques to sequence the execution of drop, alter, and add operations. FIG. 9A is a block diagram of a removal Directed Acyclic Graph (DAG) 902, constructed from an identified set of remove columns 608 and corresponding removal commands 808, and the desired state of the set of columns after executing the removal DAG in accordance with embodiments of the present technology. The removal DAG 902 in FIG. 9A corresponds to the removal commands necessary to transition the representative table depicted in FIG. 6 to the desired state 606.

The removal DAG 902 is constructed based on the identified set of removed columns 608, providing the sequence of removal commands necessary to transition the node from its current state to the desired state for the corresponding table. The removed columns 608 can include columns or other entities deemed obsolete, redundant, or no longer necessary for the operation of the node. Methods of ordering a removal DAG are discussed with reference to FIG. 10.

The removal DAG 902 contains two removal commands 808 in FIGS. 8A and 8B, namely “DROP column 2” and “DROP column 3.” The removal commands 808 instruct the system to discard specified columns (e.g., columns 2 and 3) from the table's structure in the node. By structuring the removal DAG 902 as a Directed Acyclic Graph (DAG), the system ensures that the removal commands are executed in a specific order that avoids circular dependencies or conflicts between removal operations. A DAG is a data structure consisting of vertices (nodes) and directed edges that connect these vertices. In a DAG, each edge has a direction, indicating a relationship from one vertex to another. A DAG does not contain cycles, meaning there is no way to traverse the graph starting from one vertex and following the edges to return to the same vertex without retracing any edges. Each node in the DAG represents a specific operation or task, while the edges denote the direction between the operations. For example, if operation A (e.g., “DROP column 2”) must be completed before operation B (e.g., “DROP column 3”) can start, there will be a directed edge from node A to node B in the DAG. Each removed column corresponds to a node in the removal DAG, and there are directed edges between nodes to represent dependencies between removal operations.

Upon execution of the removal DAG 902, the interim post-removal state 904 reflects the node state. The system traverses the removal DAG in topological order, ensuring that removal operations are performed in the correct sequence to avoid dependency issues (e.g., traversing in the direction of the directed edges between nodes). The removal operations are executed in such a way that if one column depends on another, the dependent column is removed only after the column it depends on has been removed. As the removal operations are executed, the system updates the node state accordingly. For each removal command in the removal DAG, the corresponding column is removed from the node, and the system updates the database schema to reflect the removal of the column and any associated metadata. In FIG. 9A, as a consequence of the removal operations, only columns 1, 4, 5, and 6 remain within the node. Columns 2 and 3 are removed from the node in accordance with the removal DAG 902.

In some implementations, the execution of the removal DAG includes logging each removal operation for auditing purposes and/or performing validation checks to ensure that the removal operations do not violate any predefined constraints or dependencies in the node. For example, the validation checks include examining the impact of the removal on other columns within the node and verifying that the removal does not violate any dependencies, established rules, or guidelines.

FIG. 9B is a block diagram of an alter DAG 906, constructed from the identified set of altered columns 610 and corresponding set of alter commands 806, and the desired state of the set of columns after executing the alter DAG in accordance with embodiments of the present technology. The alter DAG 906 in FIG. 9B corresponds to the alter commands necessary to transition the representative table depicted in FIG. 6 to the desired state 606.

The alter DAG 906 is constructed based on the identified set of altered columns 610, providing the sequence of removal commands necessary to transition the node from its current state to the desired state for the corresponding table. Examples of alterations include changes to the structure, content, or properties of columns. Once the alterations to each column have been analyzed, the system organizes the columns into a sequential order within the alter DAG 906. This sequential order ensures that the alterations are applied in a logical and coherent manner, taking into account any dependencies or relationships between columns. For example, if an altered column depends on another column for its definition or functionality, the system arranges the intra-node transformation operations accordingly to preserve data consistency. Methods of ordering a alter DAG are discussed with reference to FIG. 10.

The alter DAG 906 contains the alter commands 806 in FIGS. 8A and 8B, namely “ALTER column 1 INTEGER” and “ALTER column 4 BOOLEAN.” The alter commands 806 instruct the system to alter specified columns (e.g., columns 1 and 4) in the node's structure. The alter DAG 906 is constructed in a similar manner to the removal DAG 902 discussed in further detail with reference to FIG. 9A and FIG. 10.

The alter DAG 906 is executed by the system after the removal DAG 902 has been executed. That means that the alter DAG 906 operates on the column state as reflected in the interim post-removal state 904. Upon execution of the alter DAG 906, the node state and corresponding table is reflected in the interim post-alter state 908. The alter DAG 906 is traversed in a same or similar manner to the removal DAG 902 discussed in further detail with reference to FIG. 9A and FIG. 10. In FIG. 9B, as a consequence of the alteration operations, altered columns 610 have been modified. Namely, column 1 has changed from a BOOLEAN to an INTEGER. And Column 4 has been altered from a DATE to a BOOLEAN. Since the removal DAG 902 was executed before the alter DAG 906, columns 2 and 3 are not present in the node state since the columns have been already previously removed.

FIG. 9C is a block diagram of an add DAG 910, constructed from the identified set of add columns 612 and corresponding add commands 810, and the desired state of the set of columns after executing the add DAG in accordance with embodiments of the present technology. The add DAG 910 in FIG. 9C corresponds to the addition commands necessary to transition the representative table depicted in FIG. 6 to the desired state 606.

The add DAG 910 is constructed based on the identified set of added columns 612, providing the sequence of add commands 810 necessary to transition the node and corresponding table from its current state to the desired state. The added columns 612 include new columns, indexes, or other database elements required to accommodate changes in data requirements or business logic. The add DAG 910 contains the add commands 810 in FIGS. 8A and 8B, namely “ADD column 7 VARCHAR (655)” and “ADD column 8 DATE.” The add commands 810 instruct the system to add specified columns (e.g., columns 7 and 8) to the table structure in the node. Methods of ordering an add DAG are discussed with reference to FIG. 10.

The add DAG 910 is executed by the system after the alter DAG 906 has been executed. That means that the add DAG 910 operates on the column state as reflected in the interim post-alter state 908. Upon execution of the add DAG 910 on the executed alter DAG 906, the node state is reflected in final after-add state 912. The final after-add state 912 corresponds to the desired state 606, since all additions, alterations, and deletions have been made to the columns in the current state 602. The add DAG 910 has the same or similar structure to the removal DAG 902 discussed in further detail with reference to FIG. 9A and FIG. 10. As a consequence of the add operations, columns 1, 4, 5, and 6, 7, and 8 exist within the node table structure, since columns 7 and 8 are added to the data warehouse.

### Method of Phased Transformations of Nodes

FIG. 10 illustrates a process flow 1000 to execute the removal, alter, and add DAGs in order to generate a desired state of a set of objects in accordance with embodiments of the present technology. The set of objects represents a collection of data, which can be, for example, a set of nodes (discussed with reference to FIGS. 2-5), or data within a node such as a table (discussed with reference to FIGS. 6-9).

At step 1002, the system maintains the current state of a set of objects stored in a data warehouse. The current state 202 of the objects is described in further detail with reference to FIG. 2 (if the objects are a set of nodes) or 6 (if the objects are, for example, columns in a table). The current state of the set of objects of the data warehouse can be stored in a cache to ensure the availability of historical data and facilitate rollback or recovery processes if needed. The cache allows users to access past states of the data warehouse. By maintaining a record of previous states, the system is able to revert to earlier configurations in the event of errors or undesired modifications.

In some embodiments, the cache is stored in a cloud environment hosted by a cloud provider, or a self-hosted environment. In a cloud environment, the cache has the scalability of cloud services provided by platforms (e.g., Snowflake™, AWS™, Azure™). Storing the cache in a cloud environment entails selecting the cloud service, provisioning resources dynamically through the provider's interface or APIs, and configuring networking components for secure communication. Cloud environments allow the cache to scale storage capacity without the need for manual intervention. As the demand for storage space grows, additional resources can be automatically provisioned to meet the increased workload. Additionally, cloud-based caches can be accessed from anywhere with an internet connection, providing convenient access to historical data for users across different locations or devices.

Conversely, in a self-hosted environment, the cache is stored on a private web server. Deploying the cache in a self-hosted environment entails setting up the server with the necessary hardware or virtual machines, installing an operating system, and storing the cache. In a self-hosted environment, organizations have full control over the cache, which allows organizations to implement customized security measures and compliance policies tailored to the organization's specific needs. For example, organizations in industries with strict data privacy and security regulations, such as finance institutions, are able to mitigate security risks by storing the cache in a self-hosted environment.

In some implementations, the data warehouse includes a view. The view is generated by a query and presents the set of objects from one or more tables in a structured format without storing the set of objects. A view presents the data from one or more underlying tables in a structured format, allowing users to query and interact with the data as if it were stored in a table. The view acts as a dynamic snapshot of the underlying data, reflecting any changes made to the original tables in real-time without requiring the storage of redundant data. To implement a data warehouse as a view, the system defines the query that specifies the structure and content of the view. Querying includes selecting columns from one or more tables, applying filters or joins to combine data, and performing aggregations or calculations. For example, a query can select specific columns from a store's sales table and join them with customer information from a separate table to create a consolidated view of sales data by customer. Once the query is defined, the system executes the query to generate the view. The query engine processes the instructions in the query and retrieves the relevant data from the underlying tables. Instead of physically storing the result set, the query engine dynamically generates the view by combining the selected columns and rows according to the query logic. This allows users to access the data in a structured format without the need for redundant storage.

In some implementations, the data warehouse is a table. A table provides a structured and tabular representation of the set of objects stored in the data warehouse, where each row corresponds to a single record or observation, and each column represents a specific attribute or field of the data. To implement a data warehouse as a table, the system defines the schema of the table, which specifies the structure and data types of each column in the table. The schema definition can include the names of the columns, along with the respective data types, constraints, and other properties. For example, a sales table schema includes columns such as “Order ID,” “Customer ID,” “Product ID,” “Quantity,” and “Total Price,” each with appropriate data types such as integers, strings, or decimals. Once the table schema is defined, the system creates the table within the data warehouse. This involves executing a SQL command to create a new table with the specified schema. For instance, the SQL command “CREATE TABLE Sales (OrderID INT, CustomerID INT, ProductID INT, Quantity INT, TotalPrice DECIMAL)” creates a sales table with the defined columns and data types. After the table is created, the system can populate the table with data from various sources such as internal and/or external data feeds. The system can insert rows of data into the table using SQL INSERT statements or other data loading mechanisms provided by the DBMS. For example, the SQL command “INSERT INTO Sales VALUES (1001, 101, 200, 5, 250.00)” inserts a new record into the sales table with the specified values for each respective column (e.g., OrderID INT, CustomerID INT, ProductID INT, Quantity INT, TotalPrice DECIMAL). In some implementations, the data warehouse is a node, which is a combination of data structures such as a table, view, and/or stream.

At step 1004, the system receives a desired state of the set of objects to be achieved by modifying the current state of the set of objects to generate the desired state of the set of objects. The desired state 206 of the objects is described in further detail with reference to FIG. 2 or 6. The desired state of the set of objects of the data warehouse can be stored in a cache in the same or similar manner to the current state.

At step 1006, the system generates a set of transformations (e.g., inter-node transformations 402 and/or intra-node transformations 802) by comparing the current state of the set of objects with the desired state of the set of objects. Each transformation in the set of transformations modifies the current state of an object to a desired state of the object. Each transformation in the set of transformations can be a Structured Query Language (SQL) statement. The set of transformations include, for example, migrating tables to new locations in the data warehouse or making edits to existing tables. The set of transformations relates to altering the structure, content, and/or properties of the set of objects within the data warehouse. The dependencies between the set of transformations are based on relationships between the set of objects and the requirements of subsequent transformation operations.

The system can compare the current state of the set of objects with the desired state of the set of objects using metadata of each object in the set of objects. The metadata of the object includes one or more of: data type, schema definition, and/or data lineage. For example, the system compares the data types assigned to corresponding columns or attributes, the schema definitions specifying the structure of tables or entities, and the data lineage indicating the origin and transformations applied to the data. Further methods of comparing the current state with the desired state are discussed with reference to FIGS. 2 and 6.

In some implementations, the comparison process includes machine learning (ML) algorithms or logic to handle complex data structures and relationships. ML algorithms automatically detect patterns or anomalies in the metadata and infer potential discrepancies between the states. The system trains the selected ML models using the preprocessed metadata from both a sample current state and a sample desired state as input. During the training process, the ML models learn to recognize patterns, similarities, and deviations in the metadata that distinguish between the two states. The ML models adjust the ML models' internal parameters based on the training data to optimize the ML model's performance in detecting anomalies and discrepancies. Once the ML model is trained, the system applies the ML model to new, unseen metadata to infer potential discrepancies between states. The ML models analyze the input metadata and generate predictions or scores indicating the likelihood of each object deviating from the desired state. Objects with high anomaly scores or predictions are flagged as potential discrepancies that require transformation(s). Alternatively, the comparison process uses rule-based systems to define specific criteria or thresholds for determining whether objects meet the desired state requirements based on their metadata attributes.

In some implementations, the comparison process extends beyond individual objects to encompass relationships and dependencies between objects within the data warehouse. For example, the system analyzes the metadata to identify dependencies between nodes, tables, columns, or entities and assess how changes to one object may impact others. The system identifies relationships such as parent-child relationships between tables, where changes to a parent table's schema may necessitate corresponding changes to child tables. After identifying dependencies, the system assesses how changes to one object may impact others by tracing the propagation of changes through the dependency graph. This process involves simulating the effects of alterations, additions, or removals to individual objects and analyzing the ripple effects on dependent objects. For example, if a column is added to a table, the system may need to update queries, views, or downstream processes that rely on that column.

At step 1008, the system separates like types of transformations in the set of transformations into predefined groups of like transformations. For example, transformations that involve adding new columns to tables are grouped, while alterations to existing columns form another category. Similarly, transformations that involve adding new nodes are grouped, while alterations to existing nodes form another category. In some implementations, the system uses pattern recognition techniques, supervised learning algorithms, and/or unsupervised learning algorithms to automatically group transformations based on similarities in their features or attributes. Pattern recognition techniques analyze the properties of each transformation and cluster them into groups based on their proximity or similarity in feature space. Pattern recognition techniques use the properties of each transformation, such as the type of operation, target object, and other relevant characteristics, to cluster the transformations into groups based on their proximity or similarity in feature space. Supervised learning algorithms, such as support vector machines or decision trees, are trained on labeled data to classify transformations into predefined groups (e.g., add, alter, remove) based on their features. Unsupervised learning algorithms, such as principal component analysis or self-organizing maps, identify patterns and similarities in the transformation data without requiring labeled examples.

At step 1010, for each of the predefined groups of like transformations, the system generates deployment phases prioritizing the like transformations based on dependencies between the transformations. The predefined groups include removal, alteration, and/or addition. The predefined groups of like transformations are used to modify the current state of the set of objects in a set order. The set order can be 1) discarding objects from the data warehouse, 2) altering objects in the data warehouse, and 3) adding new objects to the data warehouse. The removal group involves discarding objects from the data warehouse, the alterations group involves altering objects currently in the data warehouse, and the addition group involves adding new objects to the data warehouse. Examples of deployment phases are discussed in further detail with reference to FIGS. 5A-5C and 9A-9C.

Each deployment phase can be defined by a directed acyclic graph. The directed acyclic graph is a one-directional graph representing corresponding transformations to be applied to each group to achieve the desired state of the objects within each deployment phase. Nodes in the directed acyclic graph represent corresponding objects associated with the predefined groups of like transformations. Edges in the directed acyclic graph represent the dependencies between the predefined groups of like transformations. The dependencies within the predefined groups of like transformations are prioritized based on a corresponding transformation's impact on downstream transformations. In some implementations, ordering the transformations in the deployment phase considers the potential impact on performance and resource utilization. For example, transformations that involve large-scale data migrations or structural changes can be scheduled during off-peak hours, and thus appear later in the ordered transformations, to minimize disruption to regular operations and optimize resource utilization.

In some implementations, the system provides a user interface to receive user input associated with the predefined groups of like transformations. The system directs, through the user input, the implementation of the predefined groups of like transformations. For example, users can opt to group transformations based on the user's preferences (e.g., such as ordering based on a transformation's function, impact, or target objects within the data warehouse).

At step 1012, the system modifies the current state of the set of objects in accordance with the deployment phases for each group of like types of transformations to generate the desired state of the objects. The modification of the current state of the set of objects can include executing the Structured Query Language (SQL) statements on the set of objects. In some implementations, the system verifies the completion of a previous transformation in the set of transformations on the set of objects. In response to the verification, the system implements the next transformation in the set of transformations on the set of objects.

### Computing Platform

FIG. 11 is a block diagram illustrating an example computer system 1100, in accordance with one or more embodiments. In some embodiments, components of the example computer system 1100 are used to implement the software platforms described herein. At least some operations described herein can be implemented on the computer system 1100.

In some embodiments, the computer system 1100 includes one or more central processing units (“processors”) 1102, main memory 1106, non-volatile memory 1110, network adapters 1112 (e.g., network interface), video displays 1118, input/output devices 1120, control devices 1122 (e.g., keyboard and pointing devices), drive units 1124 including a storage medium 1126, and a signal generation device 1120 that are communicatively connected to a bus 1116. The bus 1116 is illustrated as an abstraction that represents one or more physical buses and/or point-to-point connections that are connected by appropriate bridges, adapters, or controllers. The bus 1116, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1194 bus (also referred to as “Firewire”).

In some embodiments, the computer system 1100 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1100.

While the main memory 1106, non-volatile memory 1110, and storage medium 1126 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1128. The term “machine-readable medium” and “storage medium” shall also be taken to include any medium that is capable of storing, encoding, or carrying a set of instructions for execution by the computer system 1100. In some embodiments, the non-volatile memory 1110 or the storage medium 1126 is a non-transitory, computer-readable storage medium storing computer instructions, which is executable by one or more “processors” 1102 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1104, 1108, 1128) set at various times in various memory and storage devices in a computer device. When read and executed by one or more processors 1102, the instruction(s) cause the computer system 1100 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1110, floppy and other removable disks, hard disk drives, optical discs (e.g., compact disc read-only memory (CD-ROMS), digital versatile discs (DVDs)), and transmission-type media such as digital and analog communication links.

The network adapter 1112 enables the computer system 1100 to mediate data in a network 1114 with an entity that is external to the computer system 1100 through any communication protocol supported by the computer system 1100 and the external entity. The network adapter 1112 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1112 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

In this disclosure, the words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention. For any method disclosed herein that includes discrete steps, the steps may be conducted in any feasible order. As appropriate, any combination of two or more steps may be conducted simultaneously.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A computer-implemented method to manage data warehouse objects, the method comprising:
maintaining a current state of a set of objects stored in a data warehouse;
receiving a desired state of the set of objects to be achieved by modifying the current state of the set of objects to generate the desired state of the set of objects;
generating a set of transformations by comparing the current state of the set of objects with the desired state of the set of objects,
wherein each of the set of transformations is configured to modify a current state of an object to a desired state of the object;
separating like types of transformations in the set of transformations into predefined groups of like transformations;
for each of the predefined groups of like transformations, generating deployment phases prioritizing the like transformations based on dependencies between the transformations; and
modifying the current state of the set of objects in accordance with the deployment phases for each group of like types of transformations to generate the desired state of the objects.

2. The method of claim 1,
wherein each transformation in the set of transformations is a Structured Query Language (SQL) statement,
wherein the modification of the current state of the set of objects includes executing the Structured Query Language (SQL) statements on the set of objects.

3. The method of claim 1, wherein the set of transformations include any of:
migrating tables to new locations in the data warehouse or making edits to existing tables.

4. The method of claim 1,
wherein the predefined groups comprise removal, alteration, and addition,
wherein the removal group involves discarding objects from the data warehouse,
wherein the alteration group involves altering objects currently in the data warehouse, and
wherein the addition group involves adding new objects to the data warehouse.

5. The method of claim 1, wherein the predefined groups of like transformations are used to modify the current state of the set of objects in a set order.

6. The method of claim 5, wherein the set order comprises:
discarding objects from the data warehouse,
altering objects in the data warehouse, and
adding new objects to the data warehouse.

7. The method of claim 1, wherein each deployment phase is defined by a directed acyclic graph.

8. The method of claim 7, wherein the directed acyclic graph is a one-directional graph representing corresponding transformations to be applied to each group to achieve the desired state of the objects within each deployment phase.

9. The method of claim 1, wherein the modification of the current state of the objects further comprises:
verifying completion of a previous transformation in the set of transformations on the set of objects; and
in response to the verification, implementing a next transformation in the set of transformations on the set of objects.

10. A computer-implemented method to manage data warehouse objects, the method comprising:
comparing a current state of a set of objects with a desired state of the set of objects, the set of objects stored in a data warehouse,
wherein the desired state of the set of objects configured to be generated by modifying the current state of the set of objects;
generating a set of transformations based on the comparison,
wherein each of the set of transformations is configured to modify a current state of an object to a desired state of the object;
separating like types of transformations in the set of transformations into predefined groups of like transformations;
for each of the predefined groups of like transformations, generating deployment phases prioritizing the like transformations based on dependencies between the transformations; and
implementing the deployment phases on the current state of the set of objects to generate the desired state of the objects.

11. The method of claim 10, further comprising:
providing a user interface configured to receive user input associated with the predefined groups of like transformations; and
directing, through the user input, the implementation of the predefined groups of like transformations.

12. The method of claim 10, wherein the current state of the set of objects of the data warehouse is stored in a caching system.

13. The method of claim 10,
wherein each deployment phase is defined by a directed acyclic graph,
wherein nodes in the directed acyclic graph represents corresponding objects associated with the predefined groups of like transformations, and
wherein edges in the directed acyclic graph represents the dependencies between the predefined groups of like transformations,
wherein the dependencies within the predefined groups of like transformations are prioritized based on a corresponding transformation's impact on downstream transformations.

14. The method of claim 10,
wherein comparing the current state of the set of objects with the desired state of the set of objects uses metadata of each object in the set of objects,
wherein the metadata of the object includes one or more of: data type, schema definition, or data lineage.

15. A resource management system, comprising:
at least one hardware processor; and
at least one non-transitory memory storing instructions, which, when executed by the at least one hardware processor, cause the system to:
maintain a current state of a set of objects stored in a data warehouse;
receive a desired state of the set of objects to be achieved by modifying the current state of the set of objects to generate the desired state of the set of objects;
generate a set of transformations by comparing the current state of the set of objects with the desired state of the set of objects,
wherein each of the set of transformations is configured to modify a current state of an object to a desired state of the object;
determine a predefined group of like transformations using the set of transformations;
for the predefined group of like transformations, generate a deployment phase prioritizing the like transformations based on dependencies between the transformations; and
modify the current state of the set of objects in accordance with the deployment phase for the like transformations.

16. The system of claim 15, wherein the dependencies between the set of transformations are based on relationships between the set of objects and requirements of subsequent transformation operations.

17. The system of claim 15,
wherein a deployment phase is defined by a first directed acyclic graph,
wherein the predefined group of like transformations is a first predefined group of like transformations,
wherein after modifying the current state of the set of objects in accordance with the first directed acyclic graph, the system is further caused to:
determine a second predefined group of like transformations using the set of transformations;
for the second predefined group of like transformations, generate a second deployment phase prioritizing the like transformations based on dependencies between the transformations; and
modify the current state of the set of objects in accordance with the second deployment phase for the like types of transformations.

18. The system of claim 15, wherein the set of transformations relate to altering one or more of: structure, content, or properties of the set of objects within the data warehouse.

19. The system of claim 15,
wherein the data warehouse is a view,
wherein the view is generated by a query and presents the set of objects from one or more tables in a structured format without storing the set of objects.

20. The system of claim 15,
wherein the data warehouse is a table,
wherein the table is a structured collection of the set of objects organized into rows and columns.
